(19) United States
(12) Patent Application Publication
(10) Pub. No.: US 2005/0289082 A1
(43) Pub. Date: Dec. 29, 2005

(54) Secure electronic transfer without requiring knowledge of secret data

(75) Inventors: Max G. Morris, Seattle, WA (US); Christopher G. Kaler, Sammamish, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/192,609

(22) Filed: Jul. 29, 2005

Related U.S. Application Data
(63) Continuation-in-part of application No. 10/917,786, filed on Aug. 13, 2004.
(60) Provisional application No. 60/515,461, filed on Oct. 29, 2003.

(51) Int. Cl. G06Q 99/00

(52) U.S. Cl. 705/65

(57) ABSTRACT

A secure electronic transfer mechanism that does not require that the computing entities that are parties to the transaction be aware of the secret data used to secure the transfer. Instead, supplemental computing entities that do have access to such secret data are enlisted to assist in performing challenge-based authentication and authorization.

### CROSS-REFERENCE TO RELATED APPLICATIONS

The present application is a continuation-in-part of U.S. patent application Ser. No. 10/917,786, filed Aug. 13, 2004 (hereinafter also referred to as the “parent application”), which claims priority to U.S. provisional patent application Ser. No. 60/515,461 filed Oct. 29, 2003 (hereinafter also referred to as the “provisional application”). The parent application and the provisional application are incorporated herein by reference in their entirety.

### BACKGROUND OF THE INVENTION

1. The Field of the Invention

The present invention relates generally to the electronic transfer of electronically transferable items. More specifically, the present invention relates to the secure transfer of electronically transferable items without requiring knowledge of secret data between the transferring computing entity and the transferee computing entity.

2. Background and Relevant Art

Computing technology has transformed the way we work and play. Computing systems and devices (hereinafter also referred to simply as “computing entities”) now take a wide variety of forms including desktop computers, laptop computers, tablet PCs, Personal Digital Assistants (PDAs), household devices and the like. In its most basic form, a computing system includes system memory and one or more processors. Software in the system memory may be executed by the processor to direct the other hardware of the computing system to perform desired functions. In other computing entities, logic is implemented using hardware, or a combination or software and hardware.

Networking technologies enable computing entities to communicate even over vast distances, thereby expanding on computer functionality. For example, networking technologies enable such applications as e-mail, web browsing, file transfer, instant messaging, electronic whiteboarding, network collaboration, and the like. Accordingly, computer networks enable widespread communication and information access.

Unfortunately, computer networks also can potentially open up connected computing entities to security breaches. One type of security breach is for one computing system or user to make false claims about who they are to thereby access resources they should not have access to. In order to guard against this, an authenticatee computing entity (i.e., a computing entity that requires authentication) will often require an authenticator computing entity (i.e., a computing entity that must authenticate) to authenticate itself. The authenticatee computing entity may then make a more informed decision regarding how to interact with the authenticator computing entity.

One particularly useful form of authentication is often referred to as challenge/response authentication. In this form of authentication, when an authenticator computing entity (hereinafter also referred to as the “authenticator”) is to authenticate to an authenticatee computing entity (hereinafter also referred to as the “authenticatee”), the authenticatee sends a challenge to the authenticator. The authenticatee then generates a response (also referred to herein as an “answer”) to the challenge typically by applying a one-way hash algorithm to the challenge using secret data available to the authenticatee and authenticator. This secret data may be, for example, a password corresponding to the authenticator. The authenticator likewise also generates the same answer using the same hashing algorithm and using the same secret data. The authenticator then provides its answer to the authenticatee. The authenticatee then compares the answer that the authenticator generated with the answer that the authenticatee generated. If the answers match, then the authentication is successful. The challenge/response authentication is advantageous in that the secret data itself is not transmitted, and thus may not be intercepted.

However, this challenge/response authentication requires that the authenticator and authenticatee computing entities have access to the secret data used for authentication, and that the authenticator and authenticatee computing entities generate the answer. In some environments this may not be desirable. For example, many computing entities have limited processing power. The generation of an answer may degrade the performance of the computing entity by diverting processing power from other processes. Furthermore, the computing entities may not be themselves secure. Accordingly, an unauthorized entity might conceivably access the secret data and use that data to falsely authenticate.

Accordingly, what would be advantageous is a challenge/response authentication mechanism that does not require the authenticator and authenticatee computing entities to B generate an answer or contain the secret data itself. It would further be advantageous if following this authentication, items could be securely transferred electronically also using a challenge/response mechanism even without requiring knowledge of secret data between the transferring and receiving computing entities.

### BRIEF SUMMARY OF THE INVENTION

The foregoing problems with the prior state of the art are overcome by the principles of the present invention, which may be implemented within a network environment that includes a payer computing entity, a payee computing entity, a payment provider computing entity, a payment token computing entity, a first supplemental computing entity trusted by the payer computing entity, and a second supplemental computing entity trusted by the payment token computing entity.

Payment is enabled from the payer computing entity to the payee computing entity without these two computing entities having to share secret data. Instead, the supplemental computing entities associated with the payer and payee computing entities have access to a shared secret. This permits challenge-based authentication and authorization without the payer and payee computing-entities having to generate a challenge or an answer to the challenge.

The payer computing entity requests a payment token from the payment token computing entity. The payment token is any data structure that, when provided to the payee computing entity, allows the payee computing entity to securely transfer of funds from the payment provider computing entity.

The second supplemental computing entity provides the payment token to the payment token computing entity, uses the secret data to generate a challenge that may be solved using the secret data, and provides the challenge to the payment token computing entity.

The payment token computing entity provides the challenge to the payer computing entity in response to having received the request for the payment token from the payer computing entity. Since the payer computing entity does not have access to the secret data needed to solve the challenge, the payer computing entity provides the challenge to the first supplemental computing entity.

The first supplemental computing entity solves the challenge using the secret data to thereby generate an answer, and provides the answer to the payer computing entity. The payer computing entity provides the answer to the payment token computing entity, which then verifies the answer. In response, the payment token computing entity provides the payment token to the payer computing entity, and causes the payment providing computing entity to reserve finds for transfer to the payee computing entity. When the payee computing entity subsequently receives the payment token from the payer computing entity, the payee computing entity may then complete the transfer.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a network environment in which the principles of the present invention may be employed;

FIG. 2 illustrates a timing diagram illustrating various message exchanges within the network environment illustrated in FIG. 1 in accordance with one embodiment of the present invention;

FIG. 3 is a diagram of a message exchange that may be used to authenticate the payer and authenticatee computing entities;

FIG. 4 schematically illustrates a data structure in the form of a Simple Object Access Protocol (SOAP) envelope that includes SOAP headers in the form of billing and singing headers.

### DETAILED DESCRIPTION OF THE PREFERRED EMBODIMENTS

The principles of the present invention provide a secure electronic transfer mechanism that does not require that the two computing entities that are party to the transaction be aware of the secret data that may be used to secure the electronic transfer.

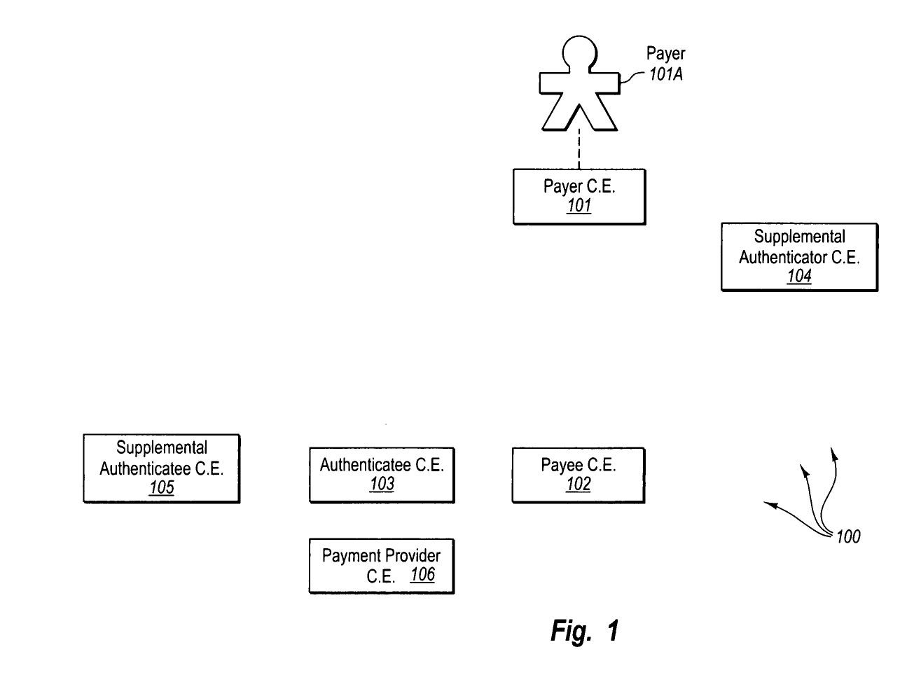

FIG. 1 illustrates an environment 100 that includes six computing entities 101 through 106. The term computing entity is abbreviated as “C.E.” in the drawings. Specifically, the six computing entities include what will be referred to as a payer computing entity 101, a payee computing entity 102, an authenticatee computing entity 103, a supplemental authenticator computing entity 104, a supplemental authenticatee computing entity 105, and a payment provider computing entity 106.

In this description and in the claims, a “computing entity” is any device or system that may retain data in memory and/or storage, and is capable of electronic communication. Such a computing entity may (but need not) be distributed. Furthermore, any two or more of the computing entities 101 through 106 may be within the same electronic device or computing system. As an example, the supplemental authenticator computing entity 104 may be a SIM card, while the payer computing entity 101 may be a mobile telephone. The principles of the present invention are not limited to this, however.

The various relationship of each of these computing entities will now be explained. The payer computing entity 101 is to make payment to a payee computing entity 102. The payer computing entity 101 may have an associated user 101A (illustrated as payer 101A) who is the actual person making payment. In one example, the payer computing entity 101 is a client device or computer, whereas the payee computing entity 102 is a service provider or perhaps a computing entity responsible for collecting payment on behalf of a service provider.

Prior to payment, the payer computing entity 101 properly authenticates with the authenticatee computing entity 103. The payee computing entity 102 trusts the authenticatee computing entity's authentication of the payer computing entity 101. In one embodiment, the payee computing entity 102 and the authenticatee computing entity 103 are integrated within the same computing system, although this is not required as shown in FIG. 1. As the authenticatee computing entity 103 plays an important role of providing a payment token, the authenticatee computing entity 103 may also be referred to herein as a “payment token” computing entity.

A supplemental authenticator computing entity 104 assists the payer computing entity 101 in authenticating to the authenticatee computing entity 103, and may be in a common sphere of trust with the payer computing entity 101. For example, if the supplemental authenticatee computing entity 104 were a SIM card inserted into the payer computing entity 101, which may be a mobile telephone, there is implicit trust in the information provided by the SIM card. Also, a supplemental authenticatee computing entity 105 assists the authenticatee computing entity 103 in authenticating the payer computing entity 101, and may also be in a common sphere of trust.

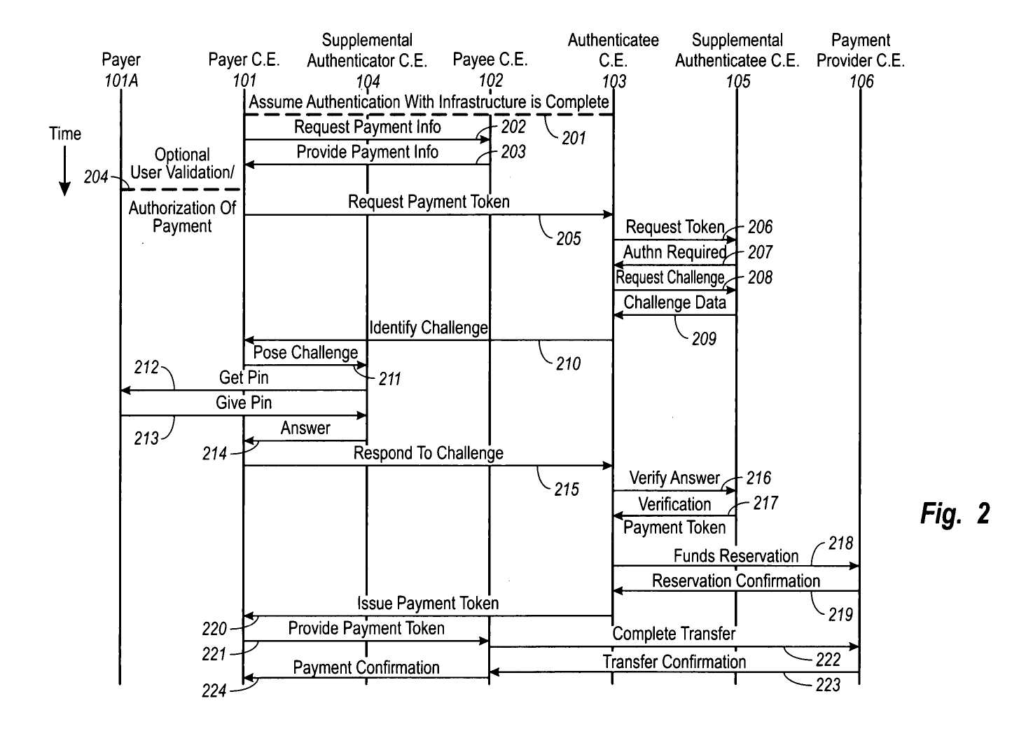

A payment provider computing entity 106 is responsible for reserving funds to be paid by the payer computing entity 101. Payment is completed when the funds are transferred to the payee computing entity 102. An embodiment of such a payment mechanism will be described below with respect to the timing diagram of FIG. 2.

FIG. 2 illustrates various message flows that occur in one embodiment between computing entities 101 through 106 and with payer 101A in order to securely transfer payment from the payer 101A to the payee computing entity 102. Each of the computing entities 101 through 106 and the payer 101A are listed at the top of FIG. 2, with a corresponding vertical line descending from each. Each message transfer is represented with an arrow originating at the vertical line that corresponds to the message origin, and terminates at the vertical line that corresponds to the message destination. FIG. 2 is provided only to show relative ordering of the message exchange, and not to imply any time interval between successive exchanges.

In discussing the message transfer, there may be references to a number of data structures such as, for example, payment token, secret data, challenge, answer, and the like. These data structure may each be a combination of correlated data structures. Such correlation may be made in any manner, including implicit correlation based on related memory location or based in the code the works with the data structure. In addition, the data structures may change over time, so long as they continue to serve in their basic function. For example, the payment token may change forms so long as it does not lose its characteristics as a token for payment.

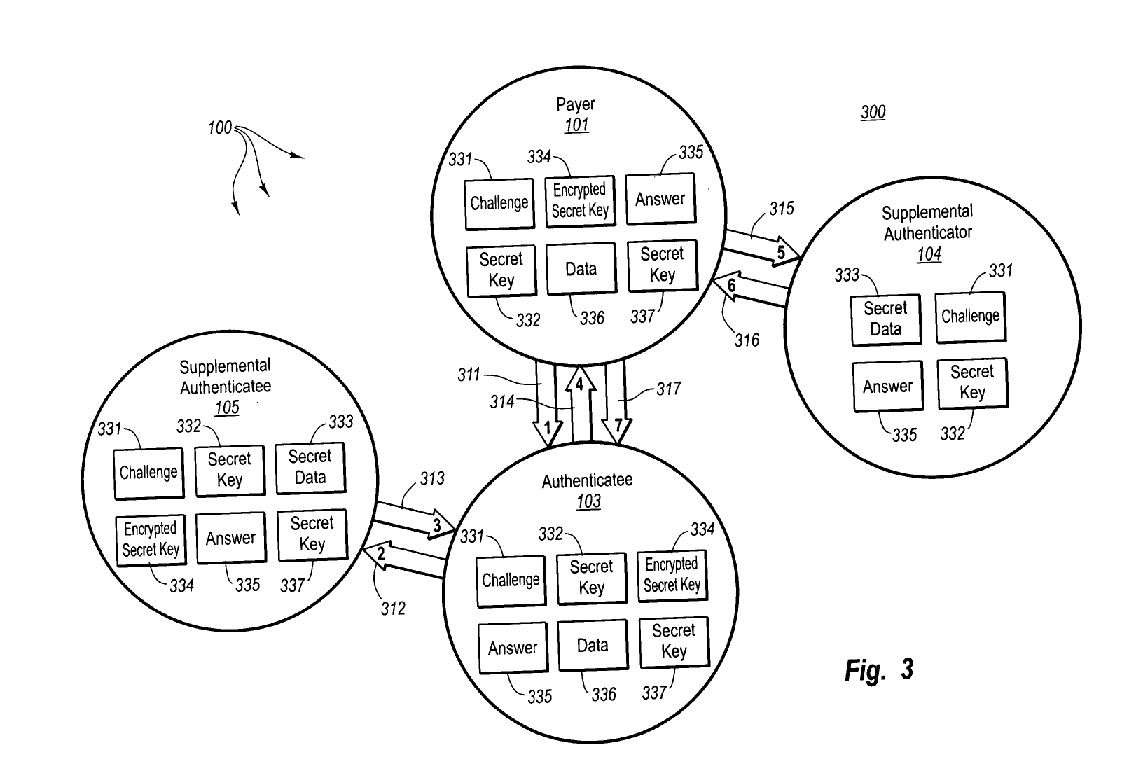

Referring to FIG. 2, the message exchange assumes that the payer computing entity 101 and the authenticatee computing entity 103 have already securely authenticated as represented by dashed line 201. One method for doing this without the payer computing entity 101 and the authenticatee 103 requiring mutual knowledge of secret data will be described with respect to the message exchange illustrated in FIG. 3.

Regardless of how the payer computing entity 101 authenticates to the authenticatee computing entity 103, the payer computing entity 101 requests payment information from the payee computing entity 102 as represented by arrow 202. The payee computing entity 102 then provides the payment information to the payer computing entity 101 as represented by arrow 203. Alternatively, the payee computing entity 102 may provide the payment information without requiring an explicit request from the payer computing entity 101. As a further alternative, the payer computing entity 101 may be able to determine the payment information based on other information such as, for example, prior negotiated prices.

At this point, the payer computing entity 101 may optionally seek express authorization from the payer 101A to make the payment as represented by dashed line 204. For example, in the example where the payer computing entity 101 is a mobile phone, the mobile phone may display the price and a selectable icon to the user. The user may then select the icon to approve the payment.

The payer computing entity 101 then requests a payment token from the authenticatee computing entity 103 as represented by arrow 205. This payment token may be any data that, when provided to the payee computing entity 102, allows the payee computing entity 102 to secure transfer of funds from the payment provider computing entity 106.

In one embodiment, the authenticatee computing entity 103 enlists the assistance of the supplemental authenticatee computing entity 105 in order to properly authorize payment. Such authorization may require knowledge of the secret data that was also used to authenticate the payer computing entity 101. Accordingly, in that embodiment, the supplemental authenticatee computing entity 105 may use that secret data in order to help the authenticatee computing entity to authorize payment as well.

Accordingly, the authenticatee computing entity 103 may request payment from the supplemental authenticatee computing entity 105 as represented by arrow 206. The supplemental authenticatee computing entity 105 may then provide the payment token as represented by arrow 217 if further evidence of authorization is not required (such as if the payment token request already contained sufficient evidence of payer authorization). However, for purposes of completeness, the case in which further authorization is required is illustrated. Accordingly, the supplemental authenticatee computing entity 105 indicates that authorization is required to the authenticatee computing entity as represented by the arrow 207.

If the authorization is to be challenge-based, then the authenticatee computing entity 103 requests a challenge from the supplemental authenticatee computing entity 105 as represented by arrow 208. This challenge may be solved by providing an answer that provides suitable assurances of payer authorization. The generation of the challenge is delegated to the supplemental authenticatee computing entity because the generation may require knowledge of the secret data known to the supplemental authenticatee computing entity 105, but not known to the authenticatee computing entity. 103.

The supplemental authenticatee computing entity 105 then provides the challenge to the authenticatee computing entity 103 as represented by the arrow 209. The authenticatee computing entity 103 then provides the challenge to the payer computing entity 101 as represented by arrow 210.

In order to solve the challenge to thereby provide a suitable answer, knowledge of the secret data known to the supplemental authenticator computing entity 104 and supplemental authenticatee computing entity 105 is important. Accordingly, in the embodiment in which the payer computing entity 101 does not also have access to this secret data, the payer computing entity 101 provides the challenge to the supplemental authenticator computing entity 104 as represented by arrow 211.

The solving of the challenge may also require some affirmation that the user authorizes payment. In the illustrated embodiment, this authorization is present in the form of a Personal Identification Number (PIN) of the user. Alternatively, fingerprint data or other evidence of authorization may be provided. In that case, the supplemental authenticator computing entity 104 then requests this assurance from the payer 101A as represented by arrow 212, whereupon the payer 101A provides this assurance as represented by arrow 213.

Using the payer evidence of authorization (e.g., the payer's PIN) and the secret data known to the supplemental authenticator computing entity 104, the supplemental authenticator computing entity 104 then solves the challenge to thereby generate an answer. The supplemental authenticator computing entity 104 then provides that answer to the payer computing entity 101 as represented by arrow 214.

The payer computing entity 101 then provides the answer to the authenticatee computing entity 103 as represented by arrow 215. The secret data is used in order to verify that the answer is correct. Accordingly, the authenticatee computing entity 103 requests that the supplemental authenticatee computing entity 105 verify the answer as represented by arrow 216. The supplemental authenticatee computing entity 105 verifies the answer using the secret data, and then provides the verification along with the payment token to the authenticatee computing entity 103 as represented by arrow 217.

The authenticatee computing entity 103 may then requests that funds be reserved by the payment provider computing entity 106 as represented by the arrow 218. The payment provider computing entity 106 would then reserve funds for future payment from the account of the payer 101A to the payee computing entity 102, and provide confirmation of this to the authenticatee computing entity 103 as represented by arrow 219.

The authenticatee computing entity 103 then issues the payment token (or a form thereof) to the payer computing entity 101 as represented by arrow 220. This payment token will be recognized by the payee computing entity 102 as evidence of funds reservation to be made from the account of the payer 101A managed by the payment provider computing entity 106 to the account of the payee computing entity 102.

The payer computing entity 101 then provides the payment token to the payee computing entity 102 as represented by arrow 221. The payee computing entity 102 may use the payment token to authorize the payment provider computing entity 106 to complete the transfer as represented by arrows 222 and 223. The payee computing entity 102 may then provide confirmation (e.g., an electronic receipt) of the transfer to the payer computing entity 101 as represented by arrow 224.

This payment transfer is advantageous in that payment is accomplished without the payer or payee computing entities needing to be aware of the secret data used to authorize (and potentially also authenticate) the payer computing entity. This mechanism also allows for the increased security associated with challenge/response protocols without requiring the payee and payer computing entities actually generate or solve the challenge. Accordingly, a wide array of potential payment scenarios is enabled.

For example, the payee computing entity 102 may be an electronic cash register. After calculating the total owned, the amount may be displayed on the customer's mobile telephone. The customer may then authorize payment, whereupon the mobile phone connects to the cash register (which may serve as both the payee and authenticatee computing entities). The register may then connect with an authorization service (a supplemental authenticatee computing entity), which issues a challenge that is ultimately received by the mobile phone. The mobile phone has its SIM card obtain a PIN from the user, and solves the challenge. The mobile phone then provides the answer to the electronic cash register, whereupon the electronic cash register has the authorization service verify the answer. Upon verification, the cash register reserves funds with a payment provider (e.g., a credit card issuer). Upon receiving confirmation of this, the cash register issues a token to the mobile phone and authenticates the exchange. The mobile phone may then just provide the payment token to the cash register, whereupon an electronic receipt is returned to the mobile telephone. The user experience would be quite seamless in this scenario. The telephone and cash register itself would not need to share any secret data. Furthermore, they would not expend processing resources generating a challenge or providing an answer.

The message exchange of FIG. 2 assumes that the payer computing entity 101 and the authenticatee computing entity 103 had previously authenticated. FIG. 3 illustrates a network environment 300 in which authentication may also occur without the payer computing entity 101 or the authenticatee computing entity 103 knowing of secret data used to perform the authentication. As illustrated, the network environment 300 includes the payer computing entity 101, the authenticatee computing entity 103, the supplemental authenticator computing entity 104 and the supplemental authenticatee computing entity 105 as these four computing entities are involved with authentication in accordance with this embodiment.

The payer computing entity 101 is to authenticate to the authenticatee computing entity 103. In the embodiment of FIG. 3, the authenticatee computing entity 103 and the supplemental authenticatee computing entity 105 are in a first common sphere of trust. The payer computing entity 101 and the supplemental authenticator computing entity 104 are also in a second common sphere of trust. The supplemental authenticatee computing entity 105 and the supplemental authenticator computing entity 104 are in a third common sphere of trust. A “sphere of trust” as used in this description and in the claims is defined as a collection of two or more computing entities in which each computing entity in the sphere of trust has received some assurance that the other computing entities are who they purport to be, and that information from the other computing entities is at least somewhat reliable.

In the description of FIG. 3, the authenticatee computing entity 103, the supplemental authenticator computing entity 104, and the supplemental authenticatee computing entity 105, may also be referred to as simply the “authenticatee 103”, the “supplemental authenticator 104”, and the “supplemental authenticatee 103”, respectively.

FIG. 3 also shows an example message flow that results in the authentication. The sequential order of a message transfer is represented sequentially by the number in the head of the arrow that represents the message transfer. The authenticatee 103 determines that the payer computing entity 101 is to authenticate. This may be accomplished by, for example, the authenticatee 103 receiving a service request (see arrow 311) from the payer computing entity 101. However, the authenticatee 103 may make the determination that the payer computing entity 101 is to be authenticated in some other manner that does not rely on any service request from the payer computing entity 101. Accordingly, the service request represented by arrow 311 is not essential.

The authenticatee 103 then acquires a challenge 331 from the supplemental authenticatee 105. This may be accomplished in any manner. However, in FIG. 3, this is as being accomplished with two message transfers represented by arrows 312 and 313. Specifically, the authenticatee 103 provides a challenge request represented by arrow 312 to the supplemental authenticatee 105. The supplemental authenticatee 105 may then generate a challenge 331 in response to the challenge request, and then provides the challenge 331 to the authenticatee 103 in response to the request as represented by arrow 313. However, there are a number of alternative ways that the authenticatee 103 may acquire the challenge 331. The challenge 331 may have been provided by the supplemental authenticatee 105 without a challenge request such as, for example, when the authenticatee 103 registers with the supplemental authenticatee 105, or perhaps at predetermined times or time intervals.

In one embodiment called herein the “subsequent private communications embodiment”, additional acts may be undertaken such that the authenticatee 103 and payer computing system 101 may subsequently communicate without relying on the supplemental authenticatee 105 and supplemental authenticator 104. For example, in the subsequent private communications embodiment, the authenticatee 103 may generate secret key data 332 that is likely not known to the payer computing entity 101, the supplemental authenticator 104, or the supplemental authenticatee 105.

The authenticatee 103 provides the secret key data 332 to the supplemental authenticatee 105 thereby informing the supplemental authenticatee 105 of the secret key data 332. The secret key data 332 may, for example, have been provided in the same message as the challenge request represented by arrow 312.

The supplemental authenticatee 105 then may encrypt the secret key data 332 using secret data 333 known to the supplemental authenticatee 105 and the supplemental authenticator 104 computing entities, but not known to the authenticatee 103 and the payer computing entity 101. The supplemental authenticatee 105 then may provide the encrypted secret key data 334 to the authenticatee 103. This encrypted secret key data 334 may be provided at the same time and/or in the same message that the supplemental authenticatee 105 used to transfer the challenge 331 as represented by arrow 313.

The authenticatee 103 then provides the challenge 331 to the payer computing entity 101 as represented by arrow 314. At the same time and/or in the same message, the authenticatee 103 may also provide the encrypted secret key data 334 to the payer computing entity 101 as represented by arrow 314.

The payer computing entity 101 then acquires an answer to the challenge 331 from the supplemental authenticator 104. This may be accomplished in any manner. However, in FIG. 3, this is illustrated as being accomplished with two message transfers represented by arrows 315 and 316. Specifically, the payer computing entity 101 provides the challenge 331 to the supplemental authenticator 104 as represented by arrow 315. The supplemental authenticator 104 may then determine an answer 335 to the challenge 331, and then provides the answer 335 to the payer computing entity 101 as represented by arrow 316. The answer may be generated by, for example, performing a one-way hash algorithm on the challenge 331 using the secret data 333.

In the subsequent private communications embodiment, the payer computing entity 101 may also provide the encrypted secret key data 334 to the supplemental authenticator 104. This may be accomplished by including the encrypted secret key data 334 in the same message as was used to transmit the challenge to the supplemental authenticator 104 as represented by arrow 315.

The supplemental authenticator 104 may then decrypt the secret key data 334 using the secret data 333 known to the supplemental authenticatee 105 and the supplemental authenticator 104, thereby informing the supplemental authenticator 104 of the secret key data 332. The supplemental authenticator 104 then provides the secret key data 332 to the payer computing entity 101 thereby informing the payer computing entity 101 of the secret key data 332. The supplemental authenticator 104 may provide the secret key data 332 back to the payer computing entity 101 potentially in the same message that was used to transfer the answer 335 to the payer computing entity 101. At this stage, both the payer computing entity 101 and authenticatee 103 have access to secret key data 332. This secret key data 332 may thus be used to authenticate each other in subsequent communications independent of the supplemental authenticator 104 and supplemental authenticatee 105.

The payer computing entity 101 provides the answer 335 to the authenticatee 103 as represented by the arrow 317. The authenticatee 103 may then use the answer 335 to authenticate the payer computing entity 101. There are a number of different ways that the authenticatee 103 may do this.

In one example, the authenticatee 103 may acquire an answer to the challenge from the supplemental authenticatee 105, potentially at the same time and in the same manner as the challenge was acquired from the supplemental authenticatee 105. The authenticatee 103 may then match the answer as acquired from the supplemental authenticatee 105 with the answer as provided by the payer computing entity 101. A match results in the payer computing entity 101 authenticating to the authenticatee 103.

Alternatively, the authenticatee 103 could delegate this comparison to the supplemental authenticatee 105 by providing the answer 335 as provided by the payer computing entity 101 to the supplemental authenticatee 105. The supplemental authenticatee 105 may then match the answer as provided by the authenticatee 103 with the answer that it internally generated. If a match is found, the supplemental authenticatee 105 may indicate to the authenticatee 103 that authentication is successful.

Accordingly, at this stage, the payer computing entity 101 has authenticated to the authenticatee 103, and the service request may be honored if appropriate. The authentication is challenge-based, and does not require the authenticatee 103 or payer computing entity 101 have access to the secret data 333 used to generate an answer to the challenge. Furthermore, in the subsequent private communications embodiment, the payer computing entity 101 and authenticatee 103 may authenticate in subsequent communications using the secret key data 332, rather than repeating the process described above.

Rather than simply securing subsequent communication based on the secret key data 332 alone, the subsequent communications may be secured using a digest of the secret key data 332 amongst one or more other items. The digest may then be used to secure subsequent communications between the payer computing entity 101 and authenticatee 103. The digest may also be based on the challenge 331 and/or the answer 335. Furthermore, the digest may include data 336 communicated between the payer computing entity 101 and the authenticatee 103 that is not also communicated to the supplemental authenticator 104 or supplemental authenticatee 105. The payer computing entity 101 and authenticatee 1.03 may then communicate using the digest to secure communications. When the digest is based in part on the data 336 that is not known to the supplemental authenticator 104 and the supplemental authenticatee 105, the supplemental authenticator 104 and the supplemental authenticatee 105 are prevented from easily eavesdropping or spoofing on subsequent communications between the payer computing entity 101 and authenticatee 103.

In one embodiment, the payer computing entity 101 also generates secret key data 337, which is provided to the supplemental authenticator 104. The supplemental authenticator 104 encrypts the secret key data 337, and passes the encrypted secret key data to the payer computing entity 101. The payer computing entity 101 then passes the encrypted secret key data to the authenticatee 103, which uses the supplemental authenticatee 105 to decrypt the secret key 337 using the secret data 333. The digest may then also be based upon this secret key 337.

Accordingly, a challenge-based authentication mechanism has been described in which the direct parties to the authentication (i.e., the payer and authenticatee computing entities) need not calculate an answer to a challenge, nor have knowledge of secret data used in the initial authentication. Furthermore, the authenticator and authenticatee computing entity may subsequently authenticate and communicate independent of the supplemental authenticator and supplemental authenticatee computing entities.

In the embodiment illustrated in FIG. 1, there are several communication channels, one between the authenticatee 103 and the supplemental authenticatee 105 (hereinafter also potentially referred to as “the authenticatee channel”), one between the payer computing entity 101 and the supplemental authenticator 104 (hereinafter also potentially referred to as the “authenticator channel”), and one between the payer computing entity 101 and the authenticatee 103 (hereinafter also potentially referred to as the “authentication channel”). If the two computing entities are within the same device or computing system, the corresponding channel may be a function call or local message mechanism. However, if the two computing entities are remotely located, the corresponding channel may use a networking protocol.

For example, if the two computing entities are located across different transport-level domains, a transport-independent network protocol may be used to communicate. One such transport-independent network protocol is known in the art as “Web Services” which uses Simple Object Access Protocol (SOAP) envelopes to convey information in a transport-independent manner. Web Services may also employ SOAP tunneling to transport across networks that do not directly support SOAP.

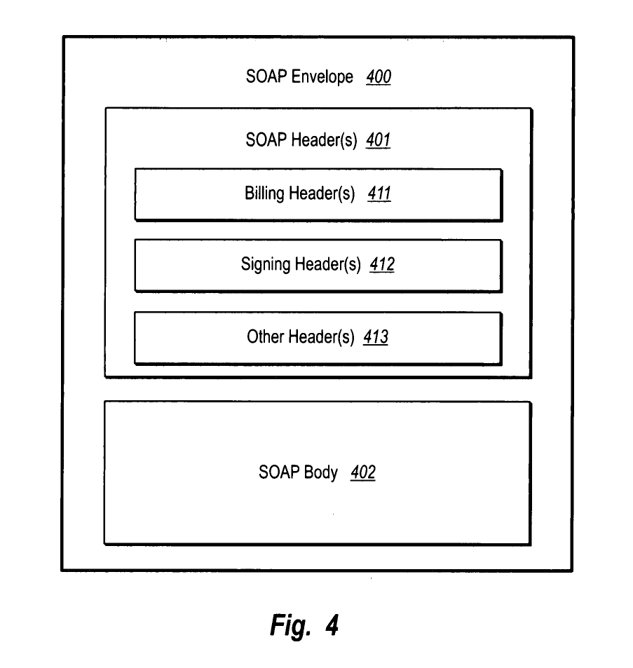

According to one aspect of the invention, a modification to conventional Web Services may be employed to convey information important to authentication. For example, a SOAP header may include a signing SOAP header as described in the U.S. provisional application 60/515,461 incorporated by reference above. FIG. 4 schematically illustrates a structure of such a SOAP envelope suitable for performing billing and signing in the context of Web Services. The SOAP envelope 400 includes SOAP headers 401 and a SOAP body 402. The SOAP headers include billing header(s) 411, signing header(s) 412, amongst potentially other headers 413. The signing headers 412 may include the information for authentication. For example, the challenge 331, the secret key 332, the encrypted secret keys 334 and 337, the answer 335, and the data 336 as well as any other useful information may be included in the signing header(s) 412. However, the principles of the present invention are not limited to communication using Web Services. It may be that none of the authenticatee, authenticator, or authentication channels use Web Services in a particular embodiment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

1. In an environment that includes a payer computing entity, a payee computing entity, a payment provider computing entity, a payment token computing entity, a first supplemental computing entity trusted by the payer computing entity, and a second supplemental computing entity trusted by the payment token computing entity, wherein the first and second supplemental computing entities have access to secret data that is not known to the payer computing entity or the payment token computing entity, a method comprising the following:
an act of the payer computing entity requesting a payment token from the payment token computing entity, the payment token being any data structure that, when provided to the payee computing entity, allows the payee computing entity to secure transfer of funds from the payment provider computing entity;
an act of the second supplemental computing entity providing the payment token to the payment token computing entity;
an act of the second supplemental computing entity using the secret data to generate a challenge that may be solved using the secret data;
an act of the second supplemental computing entity providing the challenge to the payment token computing entity;
an act of the payment token computing entity providing the challenge to the payer computing entity in response to having received the request for the payment token from the payer computing entity;
an act of the payer computing entity providing the challenge to the first supplemental computing entity;
an act of the first supplemental computing entity solving the challenge using the secret data to thereby generate an answer;
an act of the first supplemental computing entity providing the answer to the payer computing entity;
an act of the payer computing entity providing the answer to the payment token computing entity;
an act of the payment token computing entity verifying the answer;
an act of the payment token computing entity providing the payment token to the payer computing entity in response to having verified the answer;
an act of the payment token computing entity causing the payment providing computing entity to reserve funds for transfer to the payee computing entity in response to having verified the answer;
an act of the payer computing entity providing the payment token to the payee computing entity; and
once the payment token is received by the payee computing entity, an act of the payee computing entity causing the payment providing computing entity to transfer the reserved funds.

2. A method in accordance with claim 1, wherein the payment token computing entity and the payee computing entity are the same computing entity.

3. A method in accordance with claim 1, wherein the payer computing entity 3 further performs the following prior to the act of the payer computing entity requesting a payment token from the payment token computing entity:
an act of the payer computing entity receiving payment information from the payee computing entity.

4. A method in accordance with claim 3, wherein the payer computing entity further performs the following prior to the act of the payer computing entity receiving payment information from the payee computing entity:
an act of payer computing entity requesting payment information from the payee computing entity.

5. A method in accordance with claim 3, wherein the payer computing entity further performs the following after the act of the payer computing entity receiving payment information from the payee computing entity:
an act of the payer computing entity displaying at least a portion of the payment information to its user; and
an act of the payer computing entity receiving an indication that the user approves of making payment based on the displayed payment information.

6. A method in accordance with claim 5, wherein the act of the second supplemental computing entity providing the payment token to the payment token computing entity occurs in response to the payment token computing entity performing the following:
an act of the payment token provider generating a request for the payment token in response to having received the request for the payment token from the payer computing entity.

7. A method in accordance with claim 1, wherein the act of the first supplemental computing entity solving the challenge using the secret data to thereby generate an answer comprises the following:
an act of the first supplemental computing entity causing the payer computing entity to prompt the user for user authentication information; and
an act of the first supplemental computing entity solving the challenge using the secret data and the user authentication information.

8. A method in accordance with claim 1, wherein the act of the payment token computing entity verifying the answer comprises the following:
an act of the payment token computing entity receiving the answer from the second supplemental computing entity; and
an act of the payment token computing entity comparing the answer as received from the second supplemental computing entity with the answer as received by from the payer computing entity.

9. A method in accordance with claim 1, wherein the act of the payment token computing entity verifying the answer comprises the following:
an act of the payment token computing entity providing the answer to the second supplemental computing entity; and
an act of the payment token computing entity receiving an indication from the second supplemental computing entity that the answer provided by the payment token computing entity is an acceptable answer to the challenge.

10. A method in accordance with claim 1, further comprising the following:
after the payment token is received by the payee computing entity, an act of the payee computing entity providing an electronic receipt to the payer computing entity.

11. A method in accordance with claim 1, wherein the payer computing entity is a mobile device, and the payee computing entity is an electronic cash register.

12. In an environment that includes a payer computing entity, a payee computing entity, a payment provider computing entity, a payment token computing entity, a first supplemental computing entity trusted by the payer computing entity, and a second supplemental computing entity trusted by the payment token computing entity, wherein the first and second supplemental computing entities have access to secret data that is not known to the payer computing entity or the payment token computing entity, a method comprising the following:
an act of payer computing entity requesting payment information from the payee computing entity.
an act of the payer computing entity receiving payment information from the payee computing entity.
an act of the payer computing entity displaying at least a portion of the payment information to its user; and
an act of the payer computing entity receiving an indication that the user approves of making payment based on the displayed payment information.
an act of the payer computing entity requesting a payment token from the payment token computing entity, the payment token being any data structure that, when provided to the payee computing entity, allows the payee computing entity to secure transfer of funds from the payment provider computing entity;
an act of the second supplemental computing entity providing the payment token to the payment token computing entity;
an act of the second supplemental computing entity using the secret data to generate a challenge that may be solved using the secret data;
an act of the second supplemental computing entity providing the challenge to the payment token computing entity;
an act of the payment token computing entity providing the challenge to the payer computing entity in response to having received the request for the payment token from the payer computing entity;
an act of the payer computing entity providing the challenge to the first supplemental computing entity;
an act of the first supplemental computing entity solving the challenge using the secret data to thereby generate an answer;
an act of the first supplemental computing entity providing the answer to the payer computing entity;
an act of the payer computing entity providing the answer to the payment token computing entity;
an act of the payment token computing entity verifying the answer;
an act of the payment token computing entity providing the payment token to the payer computing entity in response to having verified the answer;
an act of the payment token computing entity causing the payment providing computing entity to reserve funds for transfer to the payee computing entity in response to having verified the answer;
an act of the payer computing entity providing the payment token to the payee computing entity; and
once the payment token is received by the payee computing entity, an act of the payee computing entity causing the payment providing computing entity to transfer the reserved funds.

13. A network environment comprising:
a payer computing entity;
a payee computing entity;
a payment provider computing entity;
a payment token computing entity;
a first supplemental computing entity trusted by the payer computing entity; and
a second supplemental computing entity trusted by the payment token computing entity, wherein
the first and second supplemental computing entities have access to secret data that is not known to the payer computing entity or the payment token computing entity:
the payer computing entity is configured to request a payment token from the payment token computing entity, the payment token being any data structure that, when provided to the payee computing entity, allows the payee computing entity to secure transfer of funds from the payment provider computing entity;
the second supplemental computing entity is configured to provide the payment token to the payment token computing entity;
the second supplemental computing entity is configured to use the secret data to generate a challenge that may be solved using the secret data;
the second supplemental computing entity is configured to provide the challenge to the payment token computing entity;
the payment token computing entity is configured to provide the challenge to the payer computing entity in response to having received the request for the payment token from the payer computing entity;
the payer computing entity is configured to provide the challenge to the first supplemental computing entity;
the first supplemental computing entity is configured to solve the challenge using the secret data to thereby generate an answer;
the first supplemental computing entity is configured to provide the answer to the payer computing entity;
the payer computing entity is configured to provide the answer to the payment token computing entity;
the payment token computing entity is configured to verify the answer;
the payment token computing entity is configured to provide the payment token to the payer computing entity in response to having verified the answer;
the payment token computing entity is configured to cause the payment providing computing entity to reserve funds for transfer to the payee computing entity in response to having verified the answer;
the payer computing entity is configured to provide the payment token to the payee computing entity; and
the payee computing entity is configured to cause the payment providing computing entity to transfer the reserved funds once the payment token is received by the payee computing entity.
